(19) United States
(12) Patent Application Publication
(10) Pub. No.: US 2017/0249957 A1
(43) Pub. Date: Aug. 31, 2017

(54) METHOD AND APPARATUS FOR IDENTIFYING AUDIO SIGNAL BY REMOVING NOISE

(71) Applicant: Electronics and Telecommunications Research Institute, Daejeon (KR)

(72) Inventors: Tae Jin PARK, Daejeon (KR); Seung Kwon BEACK, Daejeon (KR); Jong Mo SUNG, Daejeon (KR); Tae Jin LEE, Daejeon (KR); Jin Soo CHOI, Daejeon (KR)

(73) Assignee: Electronics and Telecommunications Research Institute, Daejeon (KR)

(21) Appl. No.: 15/445,010

(22) Filed: Feb. 28, 2017

(30) Foreign Application Priority Data
Feb. 29, 2016 (KR) 10-2016-0024089

(51) Int. Cl. G10L 25/51; G10L 21/038; G06F 17/30; G10L 25/21

(52) U.S. Cl. CPC G10L 25/51; G10L 25/21; G10L 21/038; G06F 17/30743; G10L 21/10

(57) ABSTRACT

An audio signal identification method and apparatus are provided. The audio signal identification method includes generating an amplitude map from an input audio signal, determining whether a portion of the amplitude map is a target portion corresponding to a target signal, using a pre-trained model, extracting feature data from the target portion, and identifying the audio signal based on the feature data.

### CROSS-REFERENCE TO RELATED APPLICATION

This application claims the benefit under 35 USC 119(a) of Korean Patent Application No. 10-2016-0024089, filed on Feb. 29, 2016, in the Korean Intellectual Property Office, the entire disclosure of which is incorporated herein by reference for all purposes.

### BACKGROUND

1. Field of the Invention

Embodiments relate to audio signal processing, and more particularly, to an apparatus and method for audio fingerprinting based on noise removal.

2. Description of the Related Art

Audio fingerprinting is a technology of extracting a unique feature from an audio signal, converting the unique feature to a hash code and identifying the audio signal based on an identification (ID) corresponding relationship between the audio signal and a hash code stored in advance in a database.

However, because noise is input together with the audio signal in the audio fingerprinting, it is difficult to extract the same feature as an original feature of the audio signal. Also, due to the noise, an accuracy of the audio fingerprinting may decrease.

### SUMMARY

Embodiments provide an apparatus and method for increasing an accuracy of identification of an audio signal by distinguishing a portion corresponding to the audio signal from a portion corresponding to a noise signal in an amplitude map and by extracting a feature from the portion corresponding to the audio signal.

According to an aspect, there is provided an audio signal identification method including generating an amplitude map from an input audio signal, determining whether a portion of the amplitude map is a target portion corresponding to a target signal, using a pre-trained model, extracting feature data from the target portion, and identifying the audio signal based on the feature data.

The generating may include dividing the audio signal into windows in a time domain, and converting the divided audio signal to a frequency-domain audio signal.

The generating may include visualizing an amplitude of the audio signal based on a time and a frequency.

The determining may include obtaining a probability that the portion corresponds to the target signal using the pre-trained model, and determining the portion as the target portion based on the probability.

The obtaining may include obtaining the probability based on a result obtained by applying an activation function. The pre-trained model may include at least one perceptron, and the perceptron may be used to apply a weight to each of at least one input, to add up the at least one input to which the weight is applied, and to apply the activation function to a sum of the at least one input.

The extracting may include extracting feature data from a portion determined to include the feature data (*determined as the target portion, and converting the feature data to hash data.

The identifying may include matching the hash data to audio signal identification information that is stored in advance.

According to another aspect, there is provided a training method for identifying an audio signal, the training method including receiving a plurality of sample amplitude maps including pre-identified information, determining whether a portion of each of the sample amplitude maps is a target portion corresponding to a target signal using a hypothetical model, extracting feature data from the target portion, and adjusting the hypothetical model based on the feature data and the pre-identified information.

The adjusting may include identifying the audio signal based on the feature data, and comparing the pre-identified information to a result of the identifying, and adjusting the hypothetical model.

The determining may include determining a portion of each of the sample amplitude maps using an activation function of a perceptron. The adjusting may include adjusting each of at least one weight of the perceptron based on the feature data and the pre-identified information. The hypothetical model may include at least one perceptron, and the perceptron may be used to apply a weight to each of at least one input, to add up the at least one input to which the weight is applied, and to apply the activation function to a sum of the at least one input.

According to another aspect, there is provided an audio signal identification apparatus including a generator configured to generate an amplitude map from an input audio signal, a determiner configured to determine whether a portion of the amplitude map is a target portion corresponding to a target signal, using a pre-trained model, an extractor configured to extract feature data from the target portion, and an identifier configured to identify the audio signal based on the feature data using a database.

According to another aspect, there is provided a training apparatus for identifying an audio signal, the training apparatus including a receiver configured to receive a plurality of sample amplitude maps including pre-identified information, a determiner configured to determine whether a portion of each of the sample amplitude maps is a target portion corresponding to a target signal, using a hypothetical model, and an extractor configured to extract feature data from the target portion, and an adjuster configured to adjust the hypothetical model based on the feature data and the pre-identified information.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a situation in which a recognition result is provided based on an audio signal according to an embodiment;

FIG. 2 is a flowchart illustrating an audio signal identification method according to an embodiment;

FIG. 3 is a flowchart illustrating a training method for identifying an audio signal according to an embodiment;

FIG. 4 is a block diagram illustrating an audio signal identification apparatus according to an embodiment;

FIG. 5 is a flowchart illustrating a processing process of a determiner in the audio signal identification apparatus of FIG. 4;

FIG. 6 illustrates a spectrogram used to extract a feature by excluding a noise portion according to an embodiment; and

FIG. 7 is a block diagram illustrating a training apparatus for identifying an audio signal according to an embodiment.

### DETAILED DESCRIPTION

Particular structural or functional descriptions of embodiments disclosed in the present disclosure are merely intended for the purpose of describing the embodiments and the scope of the present disclosure should not be construed as being limited to those described in the present disclosure. It will be apparent to those skilled in the art that various modifications and variations can be made from these descriptions. Reference throughout the present specification to “one embodiment”, “an embodiment”, “one example” or “an example” indicates that a particular feature, structure or characteristic described in connection with the embodiment or example is included in at least one embodiment. Thus, appearances of the phrases “in one embodiment”, “in an embodiment”, “one example” or “an example” in various places throughout the present specification are not necessarily all referring to the same embodiment or example.

Various alterations and modifications may be made to the embodiments, some of which will be illustrated in detail in the drawings and detailed description. However, it should be understood that these embodiments are not construed as limited to the illustrated forms and include all changes, equivalents or alternatives within the idea and the technical scope of this disclosure.

Although terms of “first” or “second” are used to explain various components, the components are not limited to the terms. These terms are used only to distinguish one component from another component. For example, a “first” component may be referred to as a “second” component, or similarly, the “second” component may be referred to as the “first” component within the scope of the right according to the concept of the present disclosure.

It should be noted that if it is described in the specification that one component is “connected,” “coupled,” or “joined” to another component, a third component may be “connected,” “coupled,” and “joined” between the first and second components, although the first component may be directly connected, coupled or joined to the second component. In addition, it should be noted that if it is described in the specification that one component is “directly connected” or “directly joined” to another component, a third component may not be present therebetween. Likewise, expressions, for example, “between” and “immediately between” and “adjacent to” and “immediately adjacent to” may also be construed as described in the foregoing.

The terminology used herein is for the purpose of describing particular embodiments only and is not intended to be limiting of embodiments. As used herein, the singular forms are intended to include the plural forms as well, unless the context clearly indicates otherwise. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined herein, all terms used herein including technical or scientific terms have the same meanings as those generally understood by one of ordinary skill in the art. Terms defined in dictionaries generally used should be construed to have meanings matching with contextual meanings in the related art and are not to be construed as an ideal or excessively formal meaning unless otherwise defined herein.

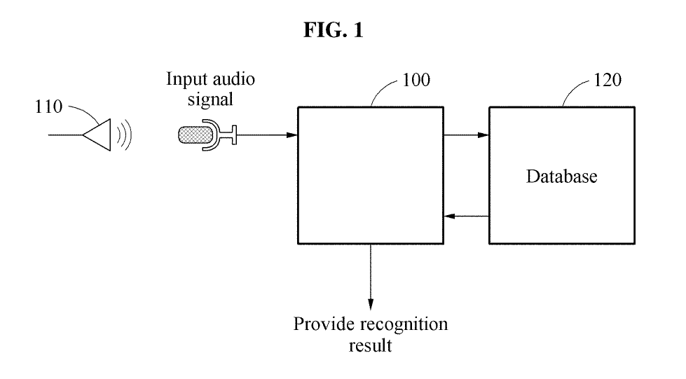

FIG. 1 is a diagram illustrating a situation in which a recognition result is provided based on an audio signal according to an embodiment.

An audio signal may be transmitted from an external speaker 110 to an audio signal identification apparatus 100 via a microphone. The audio signal identification apparatus 100 may process an input audio signal and may extract a unique feature of the audio signal. The audio signal identification apparatus 100 may convert the extracted feature to a hash code. The audio signal identification apparatus 100 may match the hash code to audio signal identification information stored in a database 120, and may output an audio signal identification (ID). The audio signal identification information stored in the database 120 may include a structure of a hash table, and the hash table may store a corresponding relationship between a plurality of hash codes and the audio signal ID.

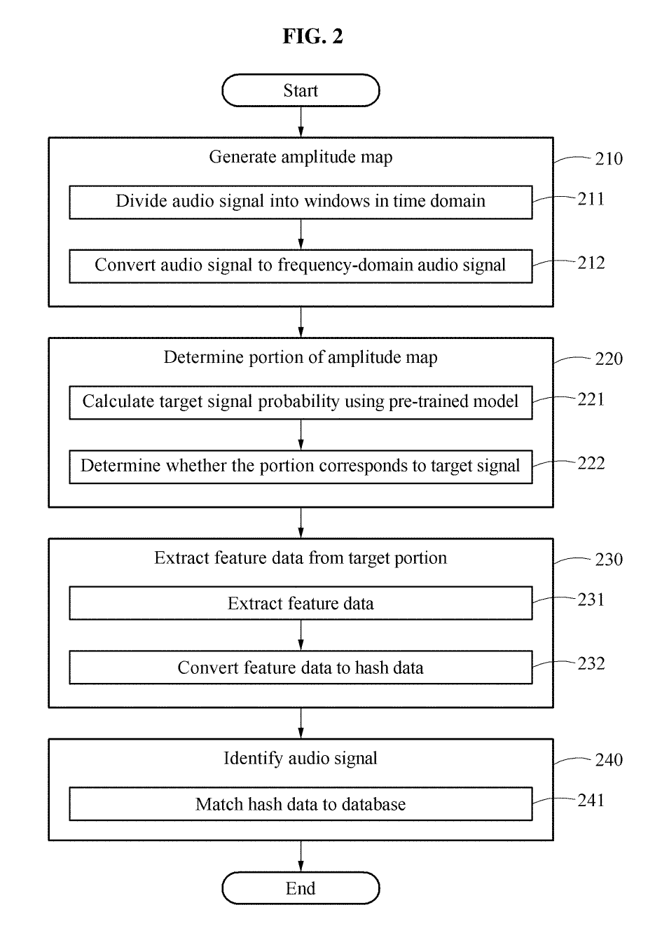

FIG. 2 is a flowchart illustrating an audio signal identification method according to an embodiment.

Referring to FIG. 2, in operation 210, the audio signal identification apparatus 100 generates an amplitude map from an input audio signal. The amplitude map may represent information about an amplitude corresponding to a specific time and a specific frequency. The amplitude map may be, for example, a spectrogram.

In operation 211, the audio signal identification apparatus 100 may divide the audio signal into windows in a time domain. For example, the audio signal identification apparatus 100 may analyze the audio signal using windows in the time domain based on an appropriate window size and an appropriate step size. As a result, the audio signal may be divided into frames, and the divided audio signal may correspond to the time domain.

In operation 212, the audio signal identification apparatus 100 may convert the divided audio signal to a frequency-domain audio signal. For example, the audio signal identification apparatus 100 may convert each of frames of the audio signal to a frequency domain. For example, the audio signal identification apparatus 100 may perform a fast Fourier transform (FFT) on each of the frames. In this example, the audio signal identification apparatus 100 may obtain an amplitude of the audio signal for each of the frames. Because the amplitude is proportional to energy, the audio signal identification apparatus 100 may obtain energy of the audio signal for each of the frames.

Also, the audio signal identification apparatus 100 may generate an amplitude map by visualizing the amplitude of the audio signal based on a time and a frequency. In the amplitude map, the time and the frequency are represented by an x-axis and a y-axis, respectively, and the amplitude map may show information about an amplitude expressed in x and y coordinates. The amplitude map may include, for example, a spectrogram.

In operation 220, the audio signal identification apparatus 100 may determine whether a portion of the amplitude map is a target portion corresponding to a target signal, using a pre-trained model. The amplitude map may be divided into a plurality of portions, and each of the portions may include at least one pixel forming the amplitude map. A pixel may be the smallest unit distinguishable based on x and y coordinates in the amplitude map. The target signal may refer to an audio signal, not a noise signal, for example, a musical signal.

In operation 221, the audio signal identification apparatus 100 may obtain a probability that the portion corresponds to the target signal, using the pre-trained model. The database 120 may store, in advance, a model trained based on a sample audio signal including a noise signal and a target signal.

According to an embodiment, a model may include at least one perceptron. The perceptron may be used to apply a weight to each of at least one input, to add up the at least one input to which the weight is applied, and to apply an activation function to a sum of the at least one input. For example, the model may be a deep learning system. The model may be, for example, a convolutional neural network (CNN) system. The database 120 may store a trained weight of each of CNNs. The weight may be referred to as a network coefficient.

The audio signal identification apparatus 100 may obtain a probability based on a result of applying the activation function. For example, the audio signal identification apparatus 100 may obtain a probability that each of portions of the amplitude map corresponds to a target signal based on a result obtained by a last activation function of at least one perceptron.

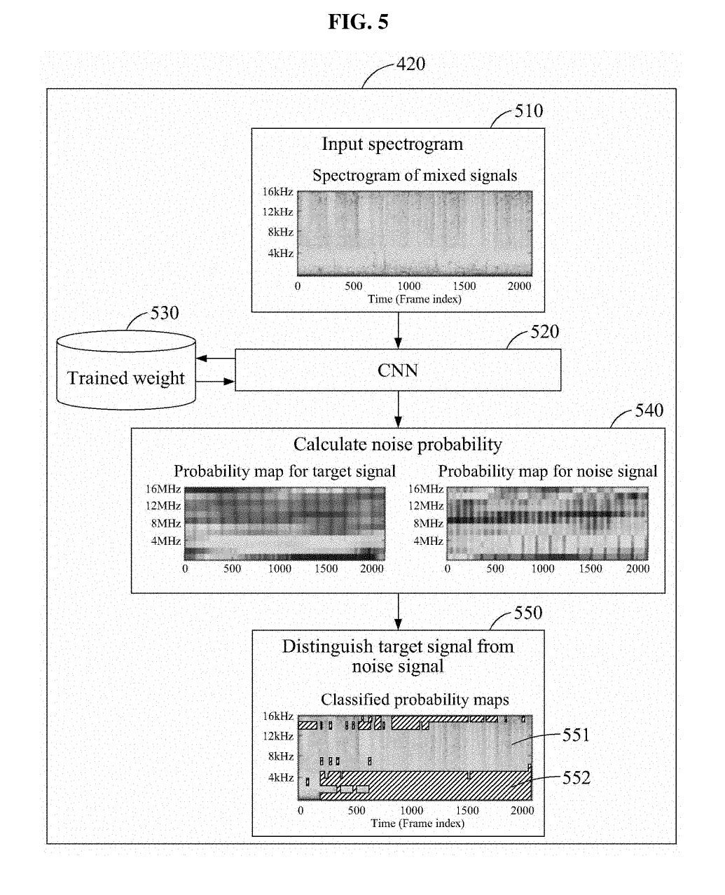

In operation 222, the audio signal identification apparatus 100 may determine the portion as the target portion based on the probability. The audio signal identification apparatus 100 may compare a probability that each of the portions of the amplitude map corresponds to the target signal to a preset criterion, to determine whether each of the portions of the amplitude map corresponds to the target signal or a noise signal. For example, when the amplitude map is a spectrogram, a portion 551 corresponding to a target signal and a portion 552 corresponding to a noise signal may be distinguished from each other as shown in FIG. 5.

In operation 230, the audio signal identification apparatus 100 extracts feature data from the target portion. The audio signal identification apparatus 100 may extract feature data from the target portion, that is, a portion of the amplitude map determined to correspond to the target signal, and may identify the audio signal with a higher accuracy based on the same resources.

In operation 231, the audio signal identification apparatus 100 may extract feature data from a portion determined to include the feature data. A target portion included in the amplitude map may represent an amplitude for a time and a frequency, and the amplitude may correspond to energy of an audio signal corresponding to a specific time and a specific frequency. The audio signal identification apparatus 100 may extract the feature data based on an energy difference between neighboring pixels.

In operation 232, the audio signal identification apparatus 100 may convert the feature data to hash data. The audio signal identification apparatus 100 may implement audio signal identification information based on a hash table. The hash table may store a corresponding relationship between the hash data and an audio signal ID. The hash data may be referred to as a hash code. When hash data is acquired from all the portions of the amplitude map using the above-described scheme, a set of the hash data may be referred to as a “fingerprint.”

In operation 240, the audio signal identification apparatus 100 identifies the audio signal based on the feature data. In operation 241, the audio signal identification apparatus 100 may match the hash data to audio signal identification information stored in the database 120. For example, the audio signal identification apparatus 100 may match a hash code to audio signal identification information stored in the database 120 and may output an audio signal ID. The audio signal identification information stored in the database 120 may include a structure of the hash table, and the hash table may store a corresponding relationship between a plurality of hash codes and the audio signal ID.

The audio signal identification apparatus 100 may exclude a portion determined to correspond to a noise signal from an amplitude map, may extract feature data from a portion determined to correspond to a target signal, and may identify an audio signal based on the feature data. Thus, it is possible to increase an accuracy of identification of the audio signal based on the same amount of feature data as that of a general fingerprinting technology. For example, when a performance of a general fingerprinting technology is 85%-500 kilobit per second (kb/s), the audio signal identification apparatus 100 may have a performance of 95%-500 kb/s. In this example, % represents an identification accuracy and kb/s represents an amount of hash data per second. Thus, the audio signal identification apparatus 100 may achieve a higher accuracy with 500 kb/s of hash data.

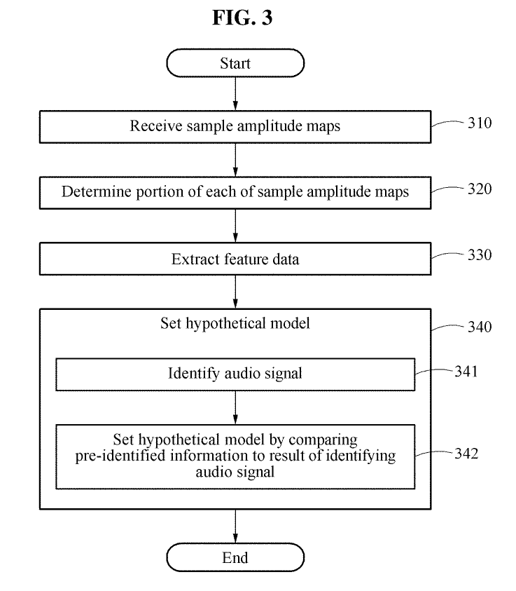

FIG. 3 is a flowchart illustrating a training method to identify an audio signal according to an embodiment.

Referring to FIG. 3, in operation 310, a training apparatus for identifying an audio signal receives a plurality of sample amplitude maps including pre-identified information. A plurality of sample audio signals corresponding to the plurality of sample amplitude maps may be identified in advance, to adjust a hypothetical model until an accuracy reaches a predetermined level by comparing an audio signal ID that is derived by training to an audio signal ID that is known in advance.

In operation 320, the training apparatus determines whether a portion of each of the sample amplitude maps corresponds to a target signal or a noise signal, using a hypothetical model. The amplitude map (*sample amplitude map may be divided into a plurality of portions, and each of the portions may refer to at least one pixel forming an amplitude map. The training apparatus may obtain a probability that a portion of a sample amplitude map corresponds to the target signal, using the hypothetical model.

The hypothetical model may include at least one perceptron. The perceptron may be used to apply a weight to each of at least one input, to add up the at least one input to which the weight is applied, and to apply an activation function to a sum of the at least one input. For example, the hypothetical model may be a deep learning system. The hypothetical model may be, for example, a CNN system. The database 120 may store a trained weight of each of CNNs. The weight may be referred to as a network coefficient.

For example, the training apparatus may obtain a probability that each of portions of a sample amplitude map corresponds to the target signal, using an activation function of a perceptron, to determine whether each of the portions of the sample amplitude map corresponds to the target signal.

In operation 330, the training apparatus extracts feature data from a portion determined to correspond to the target signal. The feature data may be extracted from the portion, that is, a target portion determined to correspond to the target signal, and thus the training apparatus may identify an audio signal with a higher accuracy based on the same resources.

In operation 340, the training apparatus adjusts the hypothetical model based on the feature data and the pre-identified information. In operation 341, the training apparatus may identify the audio signal based on the feature data. In operation 342, the training apparatus may adjust the hypothetical model by comparing the pre-identified information to a result of identifying the audio signal. In operation 342, the training apparatus may adjust each of at least one weight of the perceptron based on the feature data and the pre-identified information, to adjust the hypothetical model.

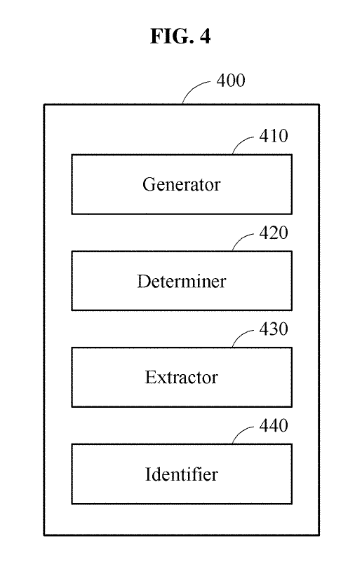

FIG. 4 is a block diagram illustrating an audio signal identification apparatus 400 according to an embodiment.

Referring to FIG. 4, the audio signal identification apparatus 400 includes a generator 410 configured to generate an amplitude map from an input audio signal, a determiner 420 configured to determine whether a portion of the amplitude map is a target portion corresponding to a target signal using a pre-trained model, an extractor 430 configured to extract feature data from the target portion, and an identifier 440 configured to identify the audio signal based on the feature data.

FIG. 5 is a flowchart illustrating a processing process of the determiner 420 of FIG. 4.

Referring to FIG. 5, in operation 510, the determiner 420 may receive the amplitude map from the generator 410. The amplitude map may represent information about an amplitude corresponding to a specific time and a specific frequency. The amplitude map may be, for example, a spectrogram. Also, the amplitude map be divided into a plurality of portions, and a portion corresponding to a target signal and a portion corresponding to a noise signal may not be distinguished in the amplitude map.

In operation 520, the determiner 420 may obtain a probability that a portion of the amplitude map corresponds to a target signal, using a pre-trained model. For example, the pre-trained model may be a deep learning system. The pre-trained model may be, for example, a CNN system. In operation 530, a trained weight of each of CNNs stored in the database 120 may be transmitted to the CNNs. The weight may be referred to as a network coefficient.

In operation 540, the determiner 420 may obtain a probability that a portion of the amplitude map corresponds to a target signal, using CNNs to which trained weights are applied. As a result, the determiner 420 may acquire a probability map for a probability that the target signal exists. Also, the determiner 420 may acquire a probability map for a probability that the noise signal exists.

In operation 550, the determiner 420 may derive a spectrogram in which a portion corresponding to the target signal and a portion corresponding to the noise signal are distinguished from each other. In the spectrogram, a horizontal axis represents a time and may be indicated by, for example, a frame index, and a vertical axis represents a frequency.

In the spectrogram, a value of an amplitude or a magnitude of energy may be represented by colors, and the portion 552 corresponds to the noise signal.

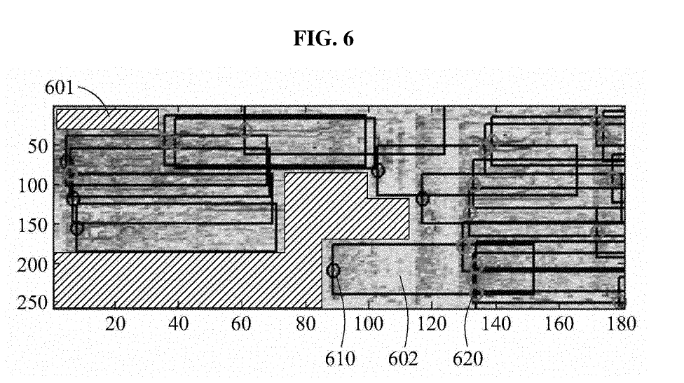

FIG. 6 illustrates a spectrogram used to extract a feature by excluding a noise portion according to an embodiment.

In the spectrogram of FIG. 6, a portion 601 corresponds to a noise signal, and a portion 602 corresponds to a target signal. The extractor 430 may extract a feature from a portion corresponding to a target signal by excluding a portion corresponding to a noise signal in the spectrogram, and thus a higher accuracy may be achieved using the same resources. For example, the extractor 430 may search for feature points 610 and 620. The extractor 430 may set a set of the feature points 610 and 620 as a feature of an input audio signal. The extractor 430 may convert feature data to hash data. The extractor 430 may match a hash code (*the hash data to audio signal identification information stored in the database 120 and may output an audio signal ID.

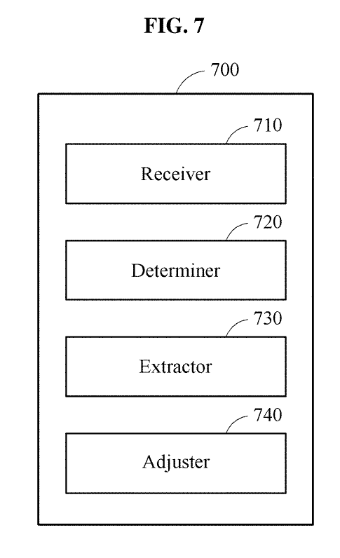

FIG. 7 is a block diagram illustrating a training apparatus 700 for identifying an audio signal according to an embodiment.

Referring to FIG. 7, the training apparatus 700 includes a receiver 710 configured to receive a plurality of sample amplitude maps including pre-identified information, a determiner 720 configured to determine whether a portion of each of the sample amplitude maps is a target portion corresponding to a target signal, using a hypothetical model, an extractor 730 configured to extract feature data from the target portion, and an adjuster 740 configured to adjust the hypothetical model based on the feature data and the pre-identified information.

According to embodiments, a portion corresponding to an audio signal and a portion corresponding to a noise signal may be distinguished from each other in an amplitude map, and a feature may be extracted from the portion corresponding to the audio signal, and thus it is possible to increase an accuracy of identification of the audio signal.

The units described herein may be implemented using hardware components, software components, or a combination thereof. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The method according to the above-described embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An audio signal identification method comprising:
generating an amplitude map from an input audio signal;
determining whether a portion of the amplitude map is a target portion corresponding to a target signal, using a pre-trained model;
extracting feature data from the target portion; and
identifying the audio signal based on the feature data.

2. The audio signal identification method of claim 1, wherein the generating comprises:
dividing the audio signal into windows in a time domain; and
converting the divided audio signal to a frequency-domain audio signal.

3. The audio signal identification method of claim 1, wherein the generating comprises visualizing an amplitude of the audio signal based on a time and a frequency.

4. The audio signal identification method of claim 1, wherein the determining comprises:
obtaining a probability that the portion corresponds to the target signal using the pre-trained model; and
determining the portion as the target portion based on the probability.

5. The audio signal identification method of claim 4, wherein the obtaining comprises obtaining the probability based on a result obtained by applying an activation function,
wherein the pre-trained model comprises at least one perceptron, and
wherein the perceptron is used to apply a weight to each of at least one input, to add up the at least one input to which the weight is applied, and to apply the activation function to a sum of the at least one input.

6. The audio signal identification method of claim 1, wherein the extracting comprises:
extracting feature data from a portion determined to include the feature data; and
converting the feature data to hash data.

7. The audio signal identification method of claim 6, wherein the identifying comprises matching the hash data to audio signal identification information that is stored in advance.

8. A training method for identifying an audio signal, the training method comprising:
receiving a plurality of sample amplitude maps comprising pre-identified information;
determining whether a portion of each of the sample amplitude maps is a target portion corresponding to a target signal, using a hypothetical model;
extracting feature data from the target portion; and
adjusting the hypothetical model based on the feature data and the pre-identified information.

9. The training method of claim 8, wherein the adjusting comprises:
identifying the audio signal based on the feature data; and
comparing the pre-identified information to a result of the identifying, and adjusting the hypothetical model.

10. The training method of claim 8, wherein the determining comprises determining a portion of each of the sample amplitude maps using an activation function of a perceptron,
wherein the adjusting comprises adjusting each of at least one weight of the perceptron based on the feature data and the pre-identified information,
wherein the hypothetical model comprises at least one perceptron, and
wherein the perceptron is used to apply a weight to each of at least one input, to add up the at least one input to which the weight is applied, and to apply the activation function to a sum of the at least one input.

11. An audio signal identification apparatus comprising:
a generator configured to generate an amplitude map from an input audio signal;
a determiner configured to determine whether a portion of the amplitude map is a target portion corresponding to a target signal, using a pre-trained model;
an extractor configured to extract feature data from the target portion; and
an identifier configured to identify the audio signal based on the feature data using a database.
